(19) United States
(12) Patent Application Publication
(10) Pub. No.: US 2008/0151961 A1
(43) Pub. Date: Jun. 26, 2008

(54) VERTICAL CAVITY SURFACE-EMITTING LASER AND METHOD OF FABRICATING THE SAME

(76) Inventors: In Kim, Suwon-si (KR); Eun-Hwa Lee, Suwon-si (KR); Sung-Won Kim, Suwon-si (KR)

Correspondence Address: CHA & REITER, LLC, 210 ROUTE 4 EAST STE 103, PARAMUS, NJ, 07652, US

(21) Appl. No.: 11/958,410

(22) Filed: Dec. 18, 2007

(30) Foreign Application Priority Data
Dec. 20, 2006 (KR) 2006-130902

(51) Int. Cl. H01S 3/083

(52) U.S. Cl. 372/94

(57) ABSTRACT

A vertical cavity surface-emitting laser (VCSEL) and a method of fabricating the same with easier alignment of a light output side aperture and an oxide aperture, The VCSEL includes: lower and upper reflection layers laminated with each other and forming a longitudinal resonance section there between; an active layer for producing a laser beam, an electrode formed in a ring shape on the upper reflection layer so the electrode has an aperture through which the laser beam is projected; a contact layer formed on the upper reflection layer; a ¼ wavelength layer formed on the contact layer such that a high transmittance area with the highest transmittance for the laser beam is formed within the aperture of the electrode; and a dielectric layer covering the contact layer and the ¼ wavelength layer, except for the electrode formed part.

### CLAIM OF PRIORITY

This application claims the benefit under 35 U.S.C. §119(a) from an application entitled “Vertical Cavity Surface-Emitting Laser and Method of Fabricating the Same,” filed in the Korean Intellectual Property Office on Dec. 20, 2006 and assigned Serial No. 2006-130902, the contents of which are hereby incorporated by reference in its entirety.

### BACKGROUND OF THE INVENTION

1. Field of the Invention

The present invention relates to a vertical cavity surface-emitting laser (VCSEL) and a method of fabricating the same.

2. Description of the Related Art

A VCSEL is a laser having a resonance cavity mainly including a multi-quantum well sandwiched between two distributed Bragg reflectors (DBRs), wherein the laser obtains a gain in output through current injection. Such a VCSEL is useful in fabricating low-priced optical modules because it exhibits circular radiation of a small angle in general. In particular, VCSELs with an 850 nm oscillating wavelength, which is suitably used for a plastic optical fiber and many kinds of polymer waveguide materials, have been representatively and widely researched because the epitaxial growth of DBR structures can be easily implemented on a GaAs substrate, and the techniques of wet thermal oxidation of an AlGaAs layer have been well defined.

Meanwhile, in order to effectively couple an optical output of a VCSEL with an optical fiber or a waveguide, it is necessary to reduce the output radiation angle of the VCSEL by increasing a current blocking layer and an oxide aperture, thereby increasing the dimension of a near field mode. The oxide aperture is an opened area of an AlGaAs current blocking layer used for forming an index distribution for obtaining a two-dimensional light confining effect. However, if the oxide aperture exceeds 5 μm, an ordinary VCSEL has a multi-mode radiation characteristic, whereby the radiation characteristic will be very irregularly varied. As a result, the VCSEL cannot exhibit a stable optical coupling characteristic.

In order to implement low-priced optical modules, research has been conducted, which employs a method of arranging a vertical light-emission device and a vertical light-reception device on a surface of a film-like optical waveguide, so that a laser beam that is produced is turned 90 degrees, thereby being incident into the waveguide.

FIG. 1 shows an example of a low-priced optical module employing a conventional film-like optical waveguide and a VCSEL chip. Referring to FIG. 1, the optical module is formed with an under-bump metallurgy pattern 6 for providing an electrode 3 and a VCSEL chip 4, both arranged on a film-like waveguide 2 with an aligning function in relation to solders 5, the film-like waveguide 2 being provided with a 45 degree reflector 1 wherein if a solder bonding process is completed by a flip chip, an under-fill 7 is coated so as to obtain an index-matching effect for reducing stress caused by a difference in the thermal expansion coefficient between the chip and the waveguide, and for preventing reflection in the waveguide. In general, the index of an index-matching gel, such as the under-fill, is similar to that of the material of the waveguide, and typically about 1.5.

However, in the structure shown in FIG. 1, in a chip test condition for confirming the characteristics of the VCSEL chip, the light-emission part is surrounded by air, the index of which is 1.0. However, after a practical module is fabricated, the light-emission part is coated with an index-matching gel, whereby the index is changed to 1.5. Due to this change in index, an oscillating threshold current Iₜₕ and drive current required for obtaining a predetermined driving optical output are varied so that the radiation angle is reduced. FIGS. 2A and 2B schematically show this situation, from which the variation of the VCSEL's characteristics before (FIG. 2A) and after (FIG. 2B) coating the index-matching gel can be seen.

In particular, if the index of the surface of the VCSEL is partially tuned so as to improve the radiation characteristic of the VCSEL, it is difficult to implement a low radiation angle characteristic because the radiation characteristic is greatly varied when the index-matching gel is coated on said surface.

### SUMMARY OF THE INVENTION

Accordingly, the present invention has been made in part to solve the at least some of the above-mentioned problems occurring in the prior art. The present invention provides a vertical cavity surface-emitting laser and a method fabricating the same.

In addition, the present invention provides a vertical cavity surface-emitting laser (VCSEL), in which in one exemplary aspect the alignment between a light output side aperture and an oxide aperture formed due to the formation of a current blocking layer can be easily implemented. The present invention includes a method of fabricating a VCSEL following steps disclosed herein below.

The VCSEL includes a DBR, (which is a component of the VCSEL), and the DBR is formed by alternately and repeatedly laminating two types of layers with different indices in such a manner that each of the layers is repeatedly laminated at a thickness corresponding to ¼ times of the wavelength in consideration of its index, or at a thickness corresponding to the sum of the above-mentioned thickness and a value obtained by multiplying a half wavelength by an integer, wherein the index of the VCSEL is determined according to the difference in index between the layers of such a DBR and the number of DBR pairs. However, in the index toward the uppermost DBR in a resonator, the entire index is differently exhibited, depending on the thickness of the uppermost layer as well as the structure of the DBR.

Therefore, an exemplary aspect of the present invention is to provide a dielectric coating structure, the transmittance of which is not varied on an area where a ¼ wavelength layer area exists and on an area formed by etching the ¼ wavelength layer before and after an index-matching gel is coated. In addition, by forming a ring-shaped aperture structure through the steps of aligning a photoresist and etching the ¼ wavelength layer at an initial stage of a VCSEL fabricating process, an oxide aperture formed due to the formation of a current blocking layer, and a ring-shaped aperture, can be accurately aligned.

According to an exemplary aspect of the present invention, there is provided a vertical cavity surface-emitting laser comprising: lower and upper reflection layers laminated with each other and forming a longitudinal resonance section between them; an active layer for producing a laser beam, the active layer being positioned between the lower and upper reflection layers; an electrode formed in a ring shape on the top reflection layer so that the electrode has an aperture, through which the laser beam transmitting the upper reflection layer is projected; a contact layer formed on the upper reflection layer; a ¼ wavelength layer formed on the contact layer in such a manner that a high transmittance area with the highest transmittance for the laser beam is formed in a ring shape within the aperture of the electrode; and a dielectric layer covering the contact layer and the ¼ wavelength layer, except the electrode formed part.

According to another exemplary aspect of the present invention, there is provided a method of fabricating a vertical cavity surface-emitting laser comprising steps of: forming a resonance section for a laser beam by laminating a lower reflection layer, an active layer, and an upper reflection layer on a semiconductor substrate; forming a contact layer on the upper reflection layer; forming a ¼ wavelength layer on the contact layer by partially etching the contact layer by a ¼ wavelength thickness such that a high transmittance area with the highest transmittance for the laser beam is formed in a ring shape within the aperture of the electrode; forming an electrode on the ¼ wavelength layer or the contact layer; and forming a dielectric layer covering the contact layer and the ¼ wavelength layer, except for the electrode formed part.

### BRIEF DESCRIPTION OF THE DRAWINGS

The above features and advantages of the present invention will be more apparent from the following detailed description taken in conjunction with the accompanying drawings, in which:

FIG. 1 shows an example of a structure of a conventional low-priced optical module employing a film-like waveguide and a VCSEL;

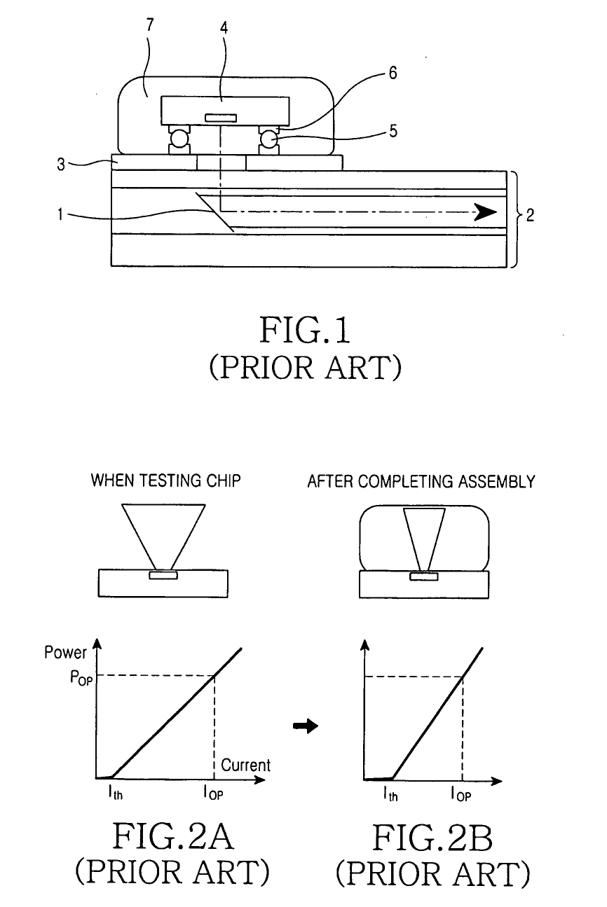

FIGS. 2A and 2B show the characteristic variation of a VCSEL before and after coating a conventional index-matching-gel;

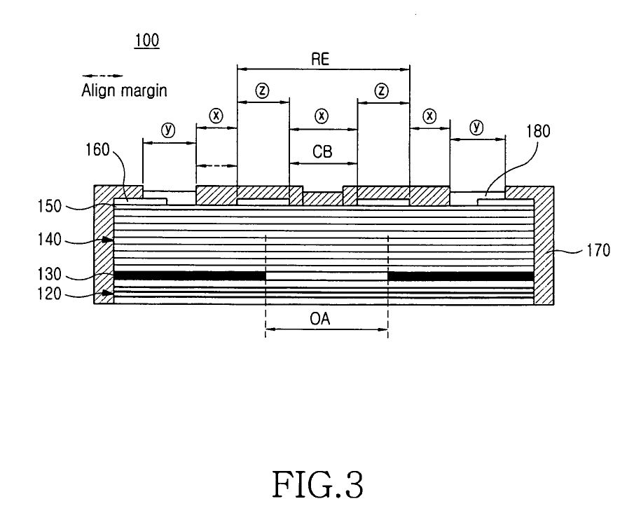

FIG. 3 is a cross-sectional view showing a structure of a VCSEL according to an exemplary embodiment of the present invention;

FIG. 4 is a graph showing the entire variation in transmittance, depending on the thickness of an additional ¼ wavelength layer;

FIG. 5 is a graph showing the entire variation in transmittance, depending on the thickness of a dielectric layer according to the present invention;

FIG. 6 is a cross-sectional view showing a structure of a VCSEL according to another exemplary embodiment of the present invention;

FIG. 7 is a view for describing mode selectivity in a VCSEL structure formed with a high transmittance area;

FIG. 8 is a graph showing the variation in transmittance according to the thickness of an additional GaAs layer, in each case where air, an index-matching-gel, or a metallic material surrounds the outside of a dielectric layer in a structure in which an SiO₂ layer with a thickness of 440 nm and an SiNₓ layer with a thickness of 60 nm are applied as the dielectric layer; and

FIGS. 9A to 9H show a process of fabricating the VCSEL shown in FIG. 3 by way of an example.

### DETAILED DESCRIPTION OF THE INVENTION

Hereinafter, exemplary embodiments of the present invention will be described with reference to the accompanying drawings. For the purposes of clarity and simplicity, a detailed description of known functions and configurations incorporated herein will be omitted as it may make the subject matter of the present invention rather unclear.

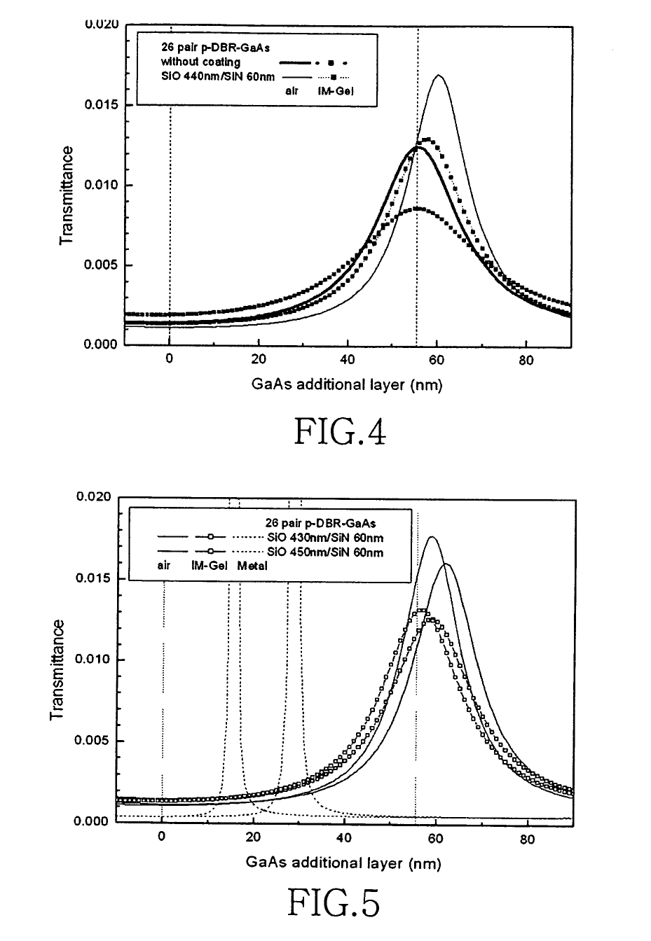

FIG. 3 shows a structure of a VCSEL according to an exemplary embodiment of the present invention, in which the VCSEL includes a ring-shaped aperture. With regard to FIG. 3, this drawing only shows an area related to an oxide aperture (OA) and an uppermost DBR. In practice, known structures, such as p, n electrodes, a polyimide layer, etc., may be applied when fabricating a VCSEL chip. The description of known structures and functions will be omitted so as not to obscure the invention with description of such known functions and structures. In addition, although description of the present embodiment relates to a VCSEL having an oscillating wavelength of 850 nm since GaAs and AlGaAs are employed, it can also be applied to the fabrication of a VCSEL having another wavelength and formed from any other material system.

Referring to the example shown in FIG. 3, the VCSEL 100 includes a quantum well active layer 120, a current blocking layer 130, an upper DBR 140, a contact layer 150, a ¼ wavelength layer 160, a dielectric layer 170, and a metal layer 180, which is an electrode.

The quantum well active layer 120 produces light through energy transition according to the recombination of electrons and holes. For example, the quantum well active layer 120 may have a laminated structure of a non-doped Al_{0.3}Ga_{0.7}As layer, a non-doped GaAs layer, and a non-doped Al_{0.3}Ga_{0.7}As layer. The current blocking layer 130 includes an oxide aperture (OA) so as to permit a laser beam to transmit the current blocking layer 130. For example, the current blocking layer 130 may be formed by partially oxidizing a p-type AlAs layer. The upper DBR 140 takes a structure in which p-type Al_{0.9}Ga_{0.1}As layers and p-type Al_{0.1}Ga_{0.9}As layers are alternately laminated. The number of the layers laminated in the upper DBR 140 is smaller than the number of the layers laminated in a lower DBR (not shown). The upper DBR and lower DBR may also be referred to as an upper reflection layer and a lower reflection layer, respectively.

The reason that the number of layers laminated in the upper DBR is smaller than the number of layers laminated in the lower DBR is to provide a difference in reflectance between the DBRs for the purpose of a laser oscillating beam is emitted through the upper DBR 140.

The contact layer 150 is the uppermost layer of the upper DBR 140 and is included in the layers laminated in the upper DBR 140. In general, if the upper DBR 140 is formed by continuously laminating two layers, each having a ¼ wavelength thickness, the DBR 140 is finished by the contact layer 150 with a high index. The contact layer 150 is composed of the layer having the relatively high index among the material constituting the DBR (140), or the material having the little higher composition than the layer having the relatively high index. For example, in case of the VCSEL with the 850 nm wavelength, the DBR (140) is constituted with Al(0.2)Ga(0.8)As and Al(0.9)Ga(0.1)As, wherein the contact layer 150 uses GaAs for applying this art to the present invention. However, the VCSEL with the 980 nm wavelength is composed of GaAs and Al(0.9)Ga(0.1)As, and at this time, the contact layer uses GaAs. The index value of each material is summarized as follows. GaAs˜3.51; Al(0.2)Ga(0.8)As˜3.44; and Al(0.9)Ga(0.1)As˜3.3.

When air is present in the outside of the contact layer 150, the entire index of the upper DBR 140 is at a maximum level while the transmittance thereof is a minimum level. In the present exemplary embodiment, the contact layer 150 may comprise a p-type GaAs layer. For the purpose of convenience, the contact layer 150 will be described separately from the upper DBR 140.

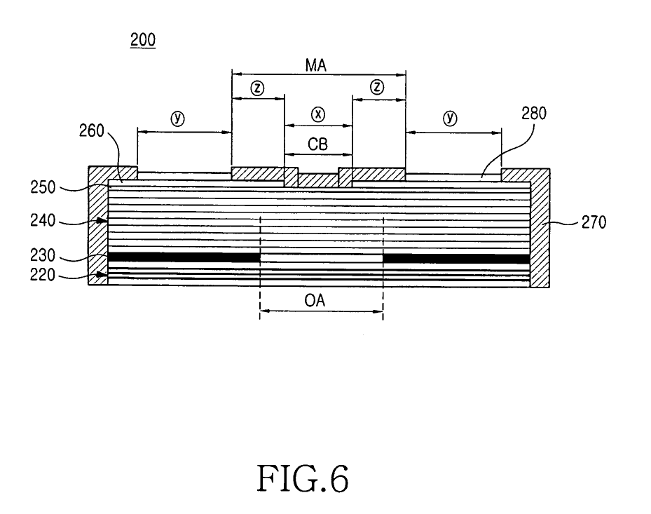

The ¼ wavelength layer 160 is a high transmittance area, which is formed in a double ring shape on the contact layer 150, so as to have a ring-shaped aperture. It is possible, but not required, that the double ring shape can be concentrically arranged. If the ¼ contact layer 160 is added on the contact layer 150 in a substantially double ringed shape, the entire transmittance of the upper DBR 140, which includes the ¼ wavelength layer 160 and the contact layer 150, will be varied. The variation in entire transmittance depending on the thickness of the additional ¼ wavelength layer 160 is shown in FIG. 4.

FIG. 4 graphically illustrates the variation in the entire transmittance resulting from different amounts of thickness of the additional ¼ wavelength layer 160, in which the additional ¼ wavelength layer 160 is formed from GaAs.

Referring to the thick solid line in FIG. 4, it can be appreciated that the transmittance is the maximum when thickness of the additional GaAs layer 160 is about 55 nm, which corresponds to the ¼ wavelength, and the ratio of the maximum transmittance to the minimum transmittance obtained when such a GaAs layer is not added, is about 9:1. It can be also appreciated that although the transmittance is sensibly varied depending on the thickness of the GaAs layer at an area adjacent to the ¼ wavelength thickness, the accuracy of etching of the GaAs layer so as to minimize the transmittance is not seriously required (i.e. accuracy of the etching does not greatly impact on transmittance).

Referring to FIG. 3, The dielectric layer 170 is formed so as to minimize the variation in transmittance when coating an index-matching gel. The dielectric layer 170 is formed by a SiO₂ layer, a SiNₓ layer, or a proper combination the thickness thereof.

Now, referring to FIG. 4 again, it can be appreciated that if the ¼ wavelength layer is etched and then an index-matching gel is coated on the etched layer (indicated by the thick solid line), the transmittance ratio as compared to the transmittance obtained when no index-matching gel is coated is abruptly reduced from 9:1 to about 4:1.

The transmittance ratio can be determined according to the composition and the thickness of the material of the dielectric layer 170. For example, if a dielectric layer formed from an SiO₂ layer, the thickness of which is 440 nm, and an SiNₓ layer, the thickness of which is 60 nm, is applied, the transmittance ratio is substantially constant as about 9:1 before and after the index-matching gel is coated, as indicated by the respective narrow solid line and the narrow dotted line.

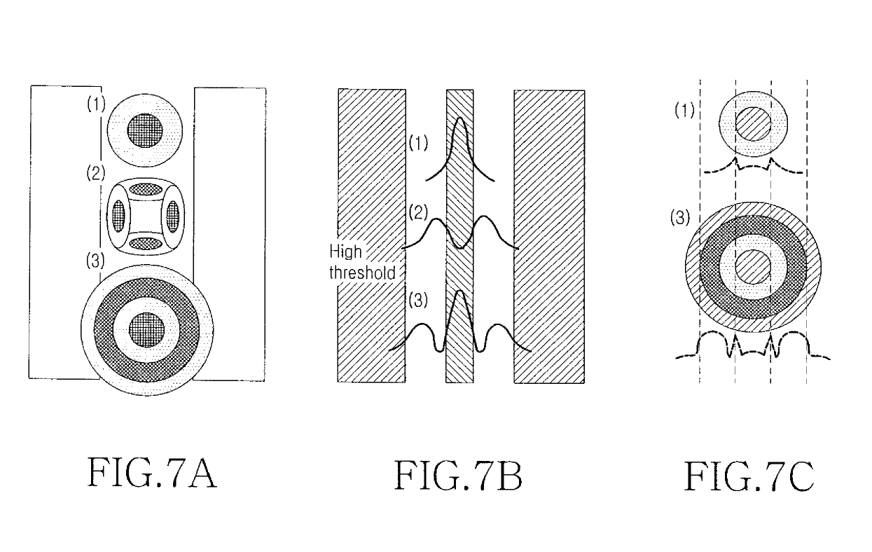

Now referring to FIG. 5, if the thickness of the dielectric layer is varied by about 10 nm, the transmittance value is varied slightly when the ¼ wavelength layer exists, or when the ¼ wavelength layer is etched, as shown in FIG. 5. However, the entire transmittance value is positioned in the range of 8:1 to 10:1. Therefore, it can be appreciated that there is a certain degree of margin in relation to the accuracy in the thickness of the dielectric layer.

In addition, while still referring to FIG. 5, it can be appreciated that when either the ¼ wavelength layer exists, or when the ¼ wavelength layer is etched, the transmittance is greatly reduced regardless of the thickness of an additional GaAs layer, in the case where the layer is covered by a metal layer. Therefore, in the structure shown in FIG. 3, a ring-shaped area with a high transmittance is formed between the areas designated as “CB” (centerblock) and “RE” (ring edge).

The metal layer 180 is formed above the contact layer 150, and the outer portions (the far most left and far most right portions of layer 160 shown in FIG. 3) of ¼ wavelength layer 160 are spaced from the inner or central portions of ¼ wavelength layer 160, which forms a ring-shaped aperture.

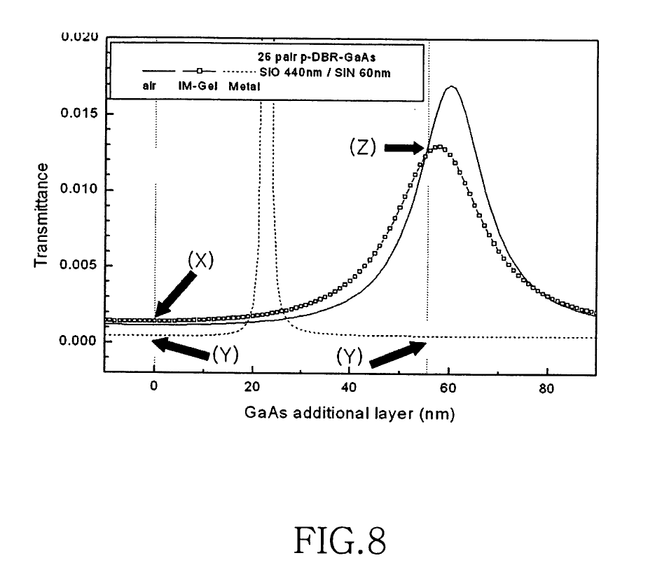

FIG. 6 shows a structure of a VCSEL according to another exemplary embodiment of the present invention, in particular a structure of a center-etched VCSEL. The VCSEL in FIG. 6 is somewhat similar to that shown in FIG. 3 in that FIG. 6 as the VCSEL shows a part associated with the oxide aperture (OA) and an uppermost DBR. In practical fabrication, such a VCSEL can be implemented by applying well-known structures, such as p, n electrodes, a polyimide layer, etc., may be applied. The description of such well-known structures is omitted.

Referring to FIG. 6, the VCSEL 200 according to the present exemplary embodiment includes a quantum well active layer 220, a current blocking layer 230, an upper DBR 240, a contact layer 250, a ¼ wavelength layer 260, a dielectric layer 270, and a metal layer 280. One way the present exemplary embodiment is distinguished from the example shown in FIG. 3 is that the ¼ wavelength layer 260 is formed in a single ring shape so as to have a center block (CB). In addition, the structure of the dielectric layer 270 and the metal layer 380 are changed due to the structural change of the ¼ layer 260, but the structure and functions of the other layers of the present exemplary embodiment are similar to the VCSEL shown in FIG. 3.

Now, the terms and functions of elements designed according to the present invention will be described with reference to two respective exemplary structures shown in FIGS. 3 and 6.

Referring to FIGS. 3 and 6, in both cases, the oxide aperture (OA) may have a diameter, for example, typically in the range of about 10 to 15 μm, and a center block (CB) area is formed by etching the ¼ wavelength layer in a diameter, for example, typically in the range of about 4 to 6 μm at the central area. It should be noted that both of the aforementioned ranges could vary from the typical diameters disclosed hereinabove. In the case of a ring-shaped aperture structure (FIG. 3), the ¼ wavelength layer is etched in the outside of the ring edge (RE) having a diameter, for example, typically in the range of about 14 to 20 μm, and in the case of a centrally etched structure (FIG. 6), the metal layer, which also serves as electrodes, has a metal aperture (MA) having a diameter, for example, typically in the range of about 14 to 20 μm.

As can be seen from the graphs shown in FIGS. 4 and 5, the ring-shaped aperture structure (FIG. 3) has a high-transmittance ring-shaped area formed at an area between CB and RE, and the centrally etched structure (FIG. 6) has a high-transmittance ring-shaped area formed at an area between CB and MA.

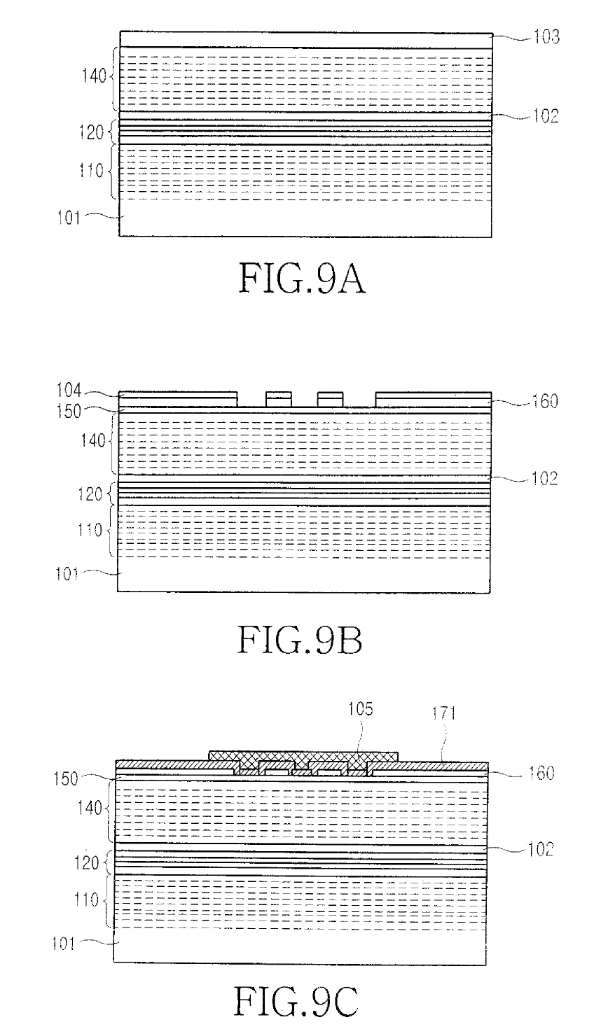

FIGS. 7A to 7C are views for describing mode selectivity in a VCSEL structure formed with a high-transmittance area. FIG. 7A shows examples of modes (in this case three modes) obtained by a respective oxide apertures, and FIG. 7B the respective magnitudes, wherein although the single mode (1) is formed at any case, higher modes, such as a mode (2) with a magnitude which is 0 at the center thereof and is varied in the peripheral direction, and a mode (3) which exhibits several different peaks in the radial direction, mainly exist when the diameter of the oxide aperture (OA) is not less than 5 μm. In an ordinary VCSEL without a ring-shaped aperture, the above-mentioned modes competitively appear depending as the driving current of the VCSEL increases. The term “competitively” means that one mode is changed to the other mode by the little change of condition although one mode is generated in a moment. In multi mode oscillate, the respectively different modes can oscillate as the main mode depending on the little change of the driving condition, and in the worse event, two modes can become the main mode in the DC driving condition by period of so short time, such like glittering two lights. As a result, the radiation characteristic of such an ordinary VCSEL may be abruptly depending on the current. In particular, in the case of the mode (2), the magnitude of which is varied in the peripheral direction, radiation is weak at the center and is greatly varied along the periphery depending on the direction thereof, which renders the mode (2) to be disadvantageous in coupling it with an optical fiber or an optical waveguide.

With a structure exhibiting high mirror loss except in the central area thereof due to the formation of CB, in the case of the mode (2) as shown in FIG. 7, threshold current is abruptly increased due to the mismatch of mode and gain, which makes it difficult to oscillate the mode. Therefore, such a CB applied VCSEL typically tends to selectively oscillate only the modes having the maximum intensity at the center thereof, wherein such modes are not varied in the peripheral direction.

When the modes formed as described above are radiated, the CB area and the area outside of the RE or MA area, which have a low transmittance, are reduced in output about 8 to 10 times as compared with the ring-shaped aperture area formed between them. As a result, a ring-shaped near field as shown in FIG. 7c is formed, whereby a radiation form having a small radiation angle and centrally concentrated can be made which is easy to be coupled to an optical fiber, a waveguide, or the like.

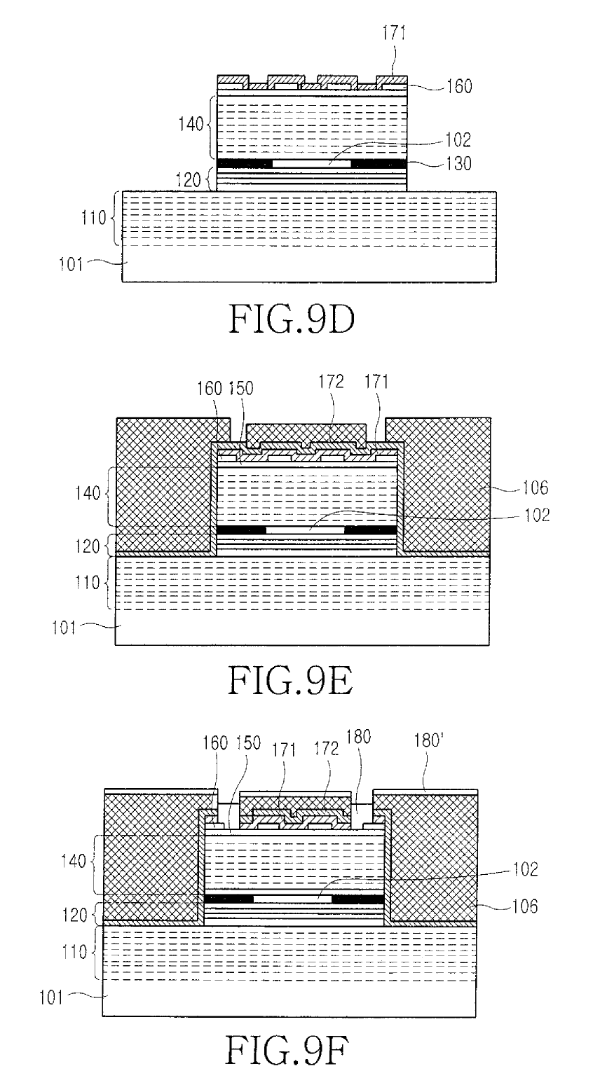

FIG. 8 graphically illustrates the variation in transmittance according to the thickness of an additional GaAs layer in a structure in which an SiO₂ layer having a thickness of 440 nm and an SiNₓ layer having a thickness of 60 nm are applied as a dielectric layer, in each case in which air, an index-matching gel or a metal exists on the outside of the dielectric layer. In order to explicitly show a transmittance at a specific GaAs thickness employed in a practical device and in the coated material, symbols (X), (Y) and (Z) are indicated with arrows, wherein (X), (Y) and (Z) are identical to symbols \textcircled{x}, \textcircled{y} and \textcircled{z} which indicate respective areas in FIGS. 3 and 6.

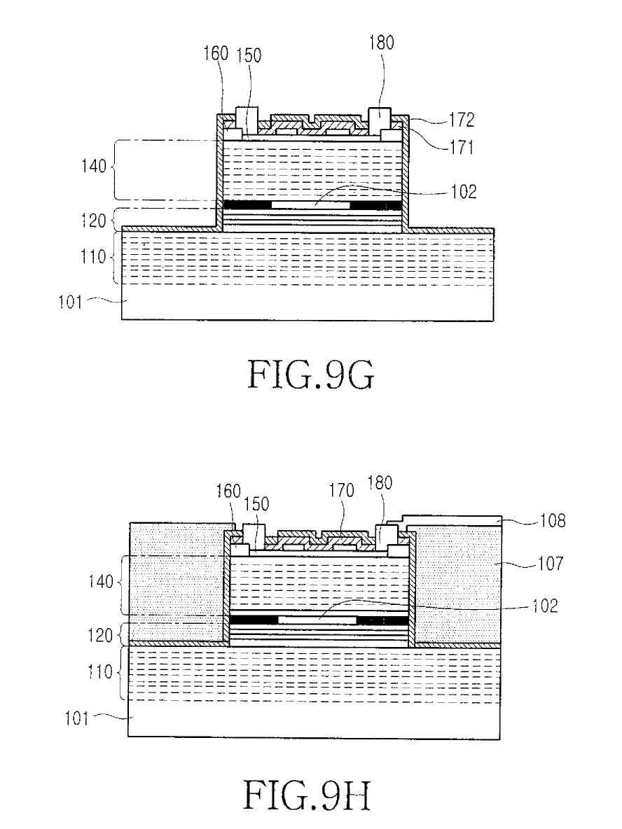

In order to describe the present invention in more detail, a method of fabricating the an example of VCSEL such as the type shown in FIG. 3 will be described with reference to FIGS. 9A to 9H.

As shown in FIG. 9A, the following layers are firstly formed: a lower DBR 110 formed by alternately laminating n-type Al_{0.9}Ga_{0.1}As layers and n-type Al_{0.1}Ga_{0.9}As layers many times on an n-type GaAs substrate 101; a quantum well active layer 120 formed by laminating a non-doped p-type Al_{0.3}Ga_{0.7}As layer, a non-doped GaAs layer and a non-doped Al_{0.3}Ga_{0.7}As layer; a p-type AlAs layer 102; an upper DBR 140 formed by alternately laminating p-type Al_{0.9}Ga_{0.1}As layers and p-type Al_{0.1}Ga_{0.9}As layers many times; and a contact layer pattern 103 formed by a p-type GaAs layer.

Referring to FIG. 9B, a photo resist (PR) pattern 104 is formed on the p-type GaAs layer 103 in a form of a desired ring-shaped aperture, and then a part of the GaAs layer 103 is etched about 55 nm deep by using, for example, a H₂PO₃:H₂O=1:20 solution. Hereinafter, in the GaAs layer, the part arriving at a depth etched so as to have the ring-shaped aperture will be referred to as a “¼ wavelength layer 160,” and the remaining part will be referred to as a “contact layer 150.”

Referring to FIG. 9C, after the photoresist pattern is removed, a photoresist pattern 105 for use in mesa-etching is formed so as to etch the outside area of the part including the ring-shaped aperture after an SiO₂ layer 171 having a thickness of 220 nm is grown, for example, by a plasma enhanced chemical vapor deposition method (PECVD method). At this time, because the top surface is substantially flat, it is possible to form the pattern, even if the photoresist is thin. Therefore, it is possible to accurately align the relative to each other the centers of the ring-shaped aperture and the mesa pattern.

Referring to FIG. 9D, a mesa pattern is formed by performing etching to the quantum well active layer 130, for example, through an inductance coupled (IC) plasma dry etching method, and then the p-type AlAs layer 102 is oxidized through a wet thermal oxidation method so that a lateral surface is exposed, thereby forming a current blocking layer 130 on the exposed part. In this example, the central part of the mesa pattern is not oxidized, whereby a substantially circular p-type AlAs layer 102 remains. The p-type AlAs layer 102 is typically referred to as an “oxide aperture (OA).”

Referring to FIG. 9E, after the photoresist used for forming the mesa pattern is removed, an additional layer 172 is formed by continuously growing an SiO₂ layer and an SiNₓ layer to have a typical thickness of about 220 nm and 60 nm, respectively, for example, through a PECVD method, so as to protect the lateral surface of the mesa formed with the oxide aperture. In addition to the SiO₂ layer described above with reference to FIG. 9C and the additional layer 172 described with reference to FIG. 9E, a dielectric layer 170 having a structure shown in FIG. 3 is formed on the mesa. Next, a photo resist pattern 106 for forming a metal layer is fabricated by using a thick photo resist that can cover the entire mesa structure.

Referring to FIG. 9F, by using the photoresist pattern 106 for forming the metal layer, the dielectric layer formed by the SiO₂ layer 171 and the SiNₓ layer 172, which are formed through the steps of FIGS. 9C and 9D, respectively, is partially etched, for example, through a reactive ion etch (RIE) method, thereby exposing the ¼ wavelength layer 160 and the contact layer 150 positioned below the dielectric layer; subsequently, the metal layers 180 and 180′ are deposited.

Referring to FIG. 9F, a lift-off process is performed so as to remove the metal layer 180′ on the photoresist pattern by dissolving the photo resist pattern 106 covered by the metal layer 180′ with acetone or a chemical suitable for dissolving photo resist patterns, thereby forming a desired metal layer 180.

Referring to FIG. 9H, through a process of coating a thick polyimide layer 107 for reducing electrostatic capacity, a process of depositing a pad-metal layer 108, a lift-off process, etc., a top electrode profile of the VCSEL is finished.

As described above, according to the present invention, an advantage of forming the VCSEL with a dielectric layer is that the transmittance is not varied on an area where a ¼ wavelength layer area exists and on an area formed by etching the ¼ wavelength layer before and after an index-matching gel is coated.

Another advantage of the present invention is that the inventive VCSEL fabricating method forms a ring-shaped aperture structure through the steps of aligning a photoresist and etching the ¼ wavelength layer at the initial stage of fabricating the VCSEL, so it is possible to render an oxide aperture and a ring-shaped aperture to be accurately aligned with precise etching that is time consuming and expensive.

Consequently, according to the present invention, it is possible to realize a VCSEL structure which does not deteriorate when epoxy or the like is coated thereon, and which is superior in a radiation angle characteristic, thus providing an advantage in facilitating a low-priced optical module employing a flip chip bonding structure, an optical fiber array, or the like.

While the invention has been shown and described with reference to certain preferred exemplary embodiments thereof, it will be understood by those skilled in the art that various changes in form and details may be made therein without departing from the spirit of the invention and the scope of the appended claims.

What is claimed is:

1. A vertical cavity surface-emitting laser comprising:
an upper reflection layer and a lower reflection layer laminated with each other and forming a longitudinal resonance section there between;
an active layer for producing a laser beam, the active layer being positioned between the upper reflection layer and a lower reflection layer;
a contact layer formed on the upper reflection layer;
an electrode formed in a ring shape on the contact layer, wherein said electrode having an aperture in the center of the ring shape in which the laser beam transmitted through the upper reflection layer is projected;
a ¼ wavelength layer formed on the contact layer such that a high transmittance area of an upper portion of the longitudinal resonance section with the highest transmittance for the laser beam is formed in a ring shape within the aperture of the electrode; and
a dielectric layer covering the contact layer and the ¼ wavelength layer, except for the electrode formed part.

2. The vertical cavity surface-emitting laser as recited in claim 1, further comprising a current blocking layer formed on a side wall of the longitudinal resonance section so that an oxide aperture is provided at the center of the resonance section, the laser beam being emitted through the oxide aperture.

3. The vertical cavity surface-emitting laser as recited in claim 2, wherein the ¼ wavelength layer is formed in a ring shape on the contact layer, except for the oxide aperture at the center of the longitudinal resonance section.

4. The vertical cavity surface-emitting laser as recited in claim 2, wherein the ¼ wavelength layer is formed in a double ring shape on the contact layer, except the center of the oxide aperture.

5. The vertical cavity surface-emitting laser as recited in claim 4, wherein the double ring shape of the ¼ wavelength layer is concentrically arranged.

6. The vertical cavity surface-emitting laser as recited in claim 1, further comprising an index-matching layer adapted to cover the dielectric layer and the electrode layer.

7. The vertical cavity surface-emitting laser as recited in claim 3, further comprising an index-matching layer adapted to cover the dielectric layer and the electrode layer.

8. The vertical cavity surface-emitting laser as recited in claim 4, further comprising an index-matching layer adapted to cover the dielectric layer and the electrode layer.

9. The vertical cavity surface-emitting laser as recited in claim 1, wherein a thickness of the composition of the dielectric layer is dependent on a predetermined wavelength of the laser beam.

10. The vertical cavity surface-emitting laser as recited in claim 3, wherein a thickness of the composition of the dielectric layer is dependent on a predetermined wavelength of the laser beam.

11. The vertical cavity surface-emitting laser as recited in claim 10, wherein the predetermined wavelength of the laser beam is about 850 nm, the dielectric layer is formed from an SiO₂ layer having a thickness of about 440 nm, and an SiNₓ layer having a thickness of about 60 nm.

12. A method of fabricating a vertical cavity surface-emitting laser comprising steps of:
forming a longitudinal resonance section for a laser beam by laminating a lower reflection layer, an active layer, and an upper reflection layer on a semiconductor substrate;
forming a contact layer on the upper reflection layer;
forming a ¼ wavelength layer on the contact layer by partially etching the contact layer by a ¼ wavelength thickness in such a manner that a high transmittance area of an upper portion of the longitudinal resonance section with the highest transmittance for the laser beam is formed within the aperture of the electrode;
forming an electrode on the ¼ wavelength layer or the contact layer; and
forming a dielectric layer covering the contact layer and the ¼ wavelength layer, except for the electrode formed part.

13. The method as recited in claim 12, wherein the electrode is formed in a ring shape with the aperture in the center, and the high transmittance area of an upper portion of the longitudinal resonance section with the highest transmittance for the laser beam is formed within the aperture of the electrode.

14. The method as recited in claim 13, further comprising step of forming a current blocking layer on a side wall of the resonance section so that an oxide aperture is provided at the center of the resonance section, the laser beam being emitted through the oxide aperture.

15. The method as recited in claim 13, further comprising the step of forming an index-matching layer on the dielectric layer.

16. The method as recited in claim 14, further comprising step of forming an index-matching layer on the dielectric layer.

17. The method as recited in claim 13, wherein the dielectric layer is formed from a SiO₂ layer having a thickness of about 440 nm and a SiNₓ layer having a thickness of about 60 nm.

18. The method as recited in claim 15, wherein the ¼ wavelength layer is formed in a double ring shape on the contact layer.

19. The method as recited in claim 18, wherein the double ring shape of the ¼ wavelength layer is concentrically arranged.
